(19) United States
(12) Patent Application Publication
(10) Pub. No.: US 2016/0044609 A1
(43) Pub. Date: Feb. 11, 2016

(54) REPORTING USER EQUIPMENT TRANSMISSION POWER HEADROOM (UPH) OF A SECONDARY UPLINK CARRIER

(71) Applicant: QUALCOMM Incorporated, San Diego, CA (US)

(72) Inventors: Omesh Kumar HANDA, Carlsbad, CA (US); Chaitanya SHAH, San Diego, CA (US); Rami Hmeidan ALNATSHEH, San Diego, CA (US); Murali Paravath MENON, Acton, MA (US); Neeharika MARUKALA, San Diego, CA (US); Syam Pavan VADAPALLI, San Diego, CA (US)

(21) Appl. No.: 14/614,905

(22) Filed: Feb. 5, 2015

Related U.S. Application Data
(60) Provisional application No. 62/034,645, filed on Aug. 7, 2014.

(51) Int. Cl. H04W 52/36

(52) U.S. Cl. CPC H04W 52/365; H04W 52/146

(57) ABSTRACT

The present disclosure presents a method and an apparatus for reporting a user equipment (UE) transmission power headroom (UPH) of a secondary uplink carrier at the UE. For example, the method may include activating the secondary uplink carrier upon receiving a message from a base station in communication with the UE to activate the secondary uplink carrier, determining whether the UE has data available for transmission from the UE to the base station, computing a UPH value of the secondary uplink carrier in response to determining that the UE has data available for transmission, and transmitting the computed UPH value to the base station. As such, timely reporting of a secondary uplink carrier UPH to improve performance may be achieved.

### CLAIM OF PRIORITY

The present application for patent claims priority to U.S. Provisional Patent Application No. 62/034,645, filed Aug. 7, 2014, entitled “Reporting of Uplink Power Headroom (UPH) of a Secondary Uplink Carrier,” which is assigned to the assignee hereof, and hereby expressly incorporated by reference herein.

### BACKGROUND

Aspects of the present disclosure relate generally to wireless communication systems, and more particularly, to reporting of user equipment (UE) transmission power headroom (UPH).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

A user equipment (UE) computes and transmits (or reports) UE transmission power headroom (UPH) of an uplink carrier to a base station and/or a network entity in communication with the UE. The UE reports the UPH or UPH value to the base station by averaging UPH values over a 100 ms duration. However, the UPH values computed and/or reported by the UE are on a dedicated physical control channel (DPCCH) basis. That is, UE reports UPH values on a per carrier or on per DPCCH basis. Therefore, in a dual cell enhanced dedicated channel (E-DCH) operation with two uplink carriers (primary and secondary uplink carriers), UE computes and/or reports UPH values separately for the primary and secondary uplink carriers.

In the dual cell E-DCH configuration, the base station may not allocate or assign any serving grants (SG) to the secondary uplink carrier when the secondary uplink carrier is activated at the UE. As a result, when the UE has to transmit data on the secondary uplink carrier, the UE may have to wait for upto 100 ms (after the activation of the secondary uplink carrier) to report the UPH value of the secondary uplink carrier to the base station which may negatively affect the performance of the UE, base station, and/or the network entity.

Thus, there is a desire for timely reporting secondary uplink carrier UPH to improve performance.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for reporting a user equipment (UE) transmission power headroom (UPH) of a secondary uplink carrier at the UE. For example, the present disclosure presents an example method for activating the secondary uplink carrier upon receiving a message from a base station in communication with the UE to activate the secondary uplink carrier, determining whether the UE has data available for transmission from the UE to the base station, computing a UPH value of the secondary uplink carrier in response to determining that the UE has data available for transmission, and transmitting the computed UPH value to the base station.

In a further aspect, the presents disclosure presents an example non-transitory computer readable medium storing computer executable code for reporting a user equipment (UE) transmission power headroom (UPH) of a secondary uplink carrier at the UE that may include code activating the secondary uplink carrier upon receiving a message from a base station in communication with the UE to activate the secondary uplink carrier, code for determining whether the UE has data available for transmission from the UE to the base station, code for computing a UPH value of the secondary uplink carrier in response to determining that the UE has data available for transmission, and code for transmitting the computed UPH value to the base station.

Furthermore, in an aspect, the present disclosure presents an example apparatus for reporting a user equipment (UE) transmission power headroom (UPH) of a secondary uplink carrier at the UE that may include a carrier activating component to activate the secondary uplink carrier upon receiving a message from a base station in communication with the UE to activate the secondary uplink carrier, a data transmission determining component to determine whether the UE has data available for transmission from the UE to the base station, a UPH computing component to compute a UPH value of the secondary uplink carrier in response to determining that the UE has data available for transmission, and a UPH value transmission component to transmit the computed UPH value to the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a flow diagram illustrating aspects of an example method in aspects of the present disclosure;

FIG. 3 is a block diagram illustrating aspects of an example user equipment including a secondary uplink carrier manager according to the present disclosure;

FIG. 4 is a block diagram conceptually illustrating an example of a telecommunications system including a user equipment with a secondary uplink carrier manager according to the present disclosure;

FIG. 5 is a conceptual diagram illustrating an example of an access network including a user equipment with a secondary uplink carrier manager according to the present disclosure;

FIG. 6 is a conceptual diagram illustrating an example of a radio protocol architecture for the user and control plane that may be used by the user equipment of the present disclosure; and

FIG. 7 is a block diagram conceptually illustrating an example of a Node B in communication with a UE, which includes a secondary uplink carrier manager according to the present disclosure, in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides a method and apparatus for reporting UPH of a secondary uplink carrier that may include activating the secondary uplink carrier upon receiving a message from a base station in communication with the UE to activate the secondary uplink carrier, determining whether the UE has data available for transmission from the UE to the base station, computing a UPH value of the secondary uplink carrier in response to determining that the UE has data available for transmission, and transmitting the computed UPH value to the base station.

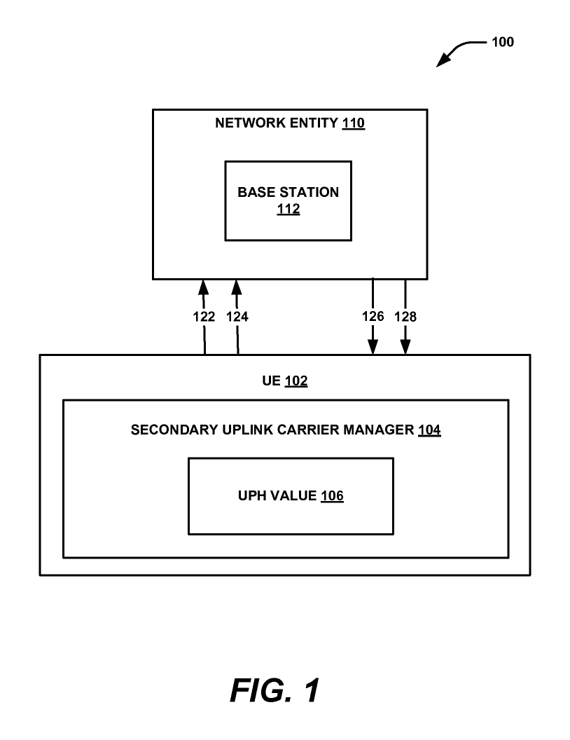

Referring to FIG. 1, a wireless communication system 100 is illustrated that facilitates reporting of a UPH of a secondary uplink carrier. For example, system 100 includes a UE 102 that may communicate with a network entity 110 and/or base station 112 via one or more over-the-air links 122, 124, 126, and/or 128. For example, UE 102 may communicate with base station 112 on uplink (UL) carriers 122 and 124, with uplink carrier 122 configured as the primary uplink carrier and/or uplink carrier 124 configured as the secondary uplink carrier in a dual cell enhanced dedicated channel (E-DCH) configuration. Additionally, UE 102 may communicate with base station 112 on downlink (DL) carriers 126 and/or 128. For instance, the UL carriers are generally used for communication from UE 102 to base station 112 and/or the DL carriers are generally used for communication from base station 112 to UE 102.

In an aspect, network entity 110 may include one or more of any type of network components, for example, an access point, including a base station (BS) or Node B or eNode B or a femto cell, a relay, a peer-to-peer device, an authentication, authorization and accounting (AAA) server, a mobile switching center (MSC), a radio network controller (RNC), etc., that can enable UE 102 to communicate and/or establish and maintain wireless communication links 122, 124, 126, and/or 128, which may include a communication session over a frequency or a band of frequencies that form a communication channel, to communicate with network entity 110 and/or base station 112. In an additional aspect, for example, base station 112 may operate according to a radio access technology (RAT) standard, e.g., GSM, CDMA, W-CDMA, HSPA or a long term evolution (LTE).

In an additional aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, UE 102 may be configured to include a secondary uplink carrier manager 104 for reporting UPH of secondary uplink carrier 124 to base station 112 and/or network entity 110. For example, in an aspect, secondary uplink carrier manager 104 may compute and/or transmit UPH value 106 of the secondary uplink carrier 124 in response to determining that UE 102 has data available for transmission upon activation of secondary uplink carrier 124. In an additional aspect, UPH value 106 of UE 102 is computed over a duration that is less than 100 milliseconds after the activation of the secondary uplink carrier for improving performance of UE 102 and/or base station 110. In a further additional aspect, UE 102 and/or secondary uplink carrier manager 104 may receive a serving grant from the base station to transmit data on the secondary uplink carrier to base station 112.

Additional aspects, which may be performed in combination with the above aspects or independently thereto, are discussed below and may lead to reporting of UPH of a secondary uplink carrier with accurate values and/or in a timely manner.

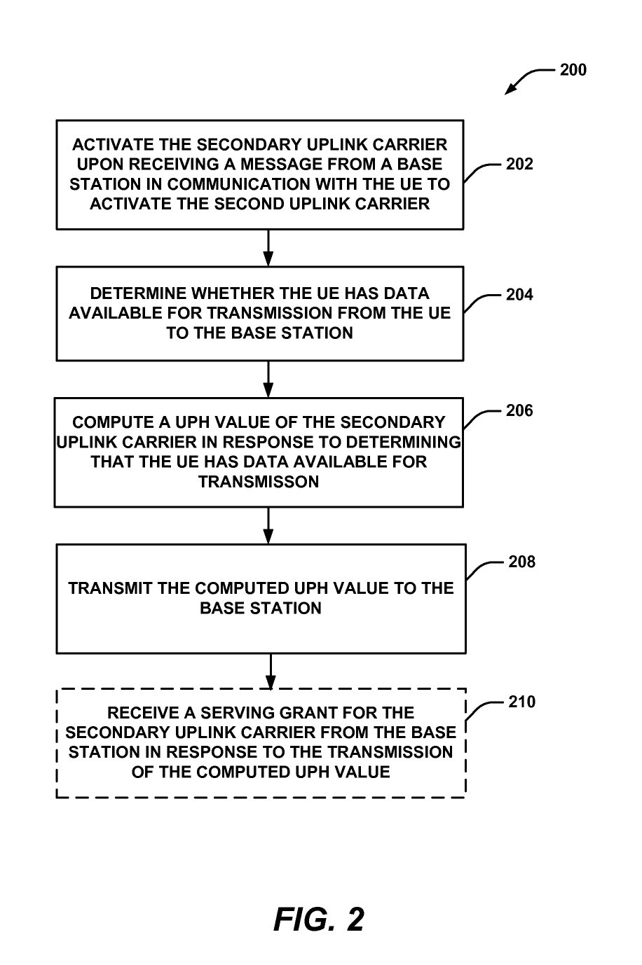

FIG. 2 illustrates an example methodology 200 for reporting UPH of a secondary uplink carrier.

For instance, in an aspect, UE 102 and/or secondary uplink carrier manager 104 may compute and report UPH value 106 of secondary uplink carrier 124 upon its activation without waiting for 100 ms, as defined in the 3GPP Specifications. The UE computes and reports UPH value 106 of secondary uplink carrier 124 when there is data to be transmitted on secondary uplink carrier 124 and the UE did not receive any serving grants (SGs) from base station 112 at activating time of secondary uplink carrier 124. The computing and reporting of the UPH value of the secondary uplink carrier during the time period which is less than 100 ms allows the UE to timely and/or accurately report the UPH value of the secondary uplink carrier to the base station to improve performance of the UE and/or the base station, as described in detail below.

In an aspect, at block 202, methodology 200 may include activating the secondary uplink carrier upon receiving a message from a base station in communication with the UE to activate the secondary uplink carrier. For example, in an aspect, UE 102 and/or secondary uplink carrier manager 104 may include a specially programmed processor module, or a processor executing specially programmed code stored in a memory, to activate the secondary uplink carrier (e.g., uplink carrier 124) upon receiving a message from a base station (e.g., base station 112) and/or network entity 110 in communication with UE 102 to activate secondary uplink carrier 124.

For instance, in an aspect, UE 102 and/or secondary uplink carrier manager 104 may activate secondary uplink carrier 124 upon receiving a message from base station 112 and/or network entity 110 to activate the secondary uplink carrier. In a dual cell E-DCH configuration, the secondary uplink carrier is pre-configured (e.g., ready access to configuration information of the secondary uplink carrier) at the UE to minimize the delay associated with activation of the secondary uplink carrier as the configuration information is already available at the UE. In an additional aspect, the message received from base station 112 and/or network entity 110 may be a high speed shared control channel (HS-SCCH) order, a Layer 1/physical layer message, instructing the UE to activate the secondary uplink carrier based on the pre-configured information already available at the UE. For example, in an aspect, the HS-SCCH order reduces the latency involved in Layer 3 (e.g., RRC) signaling as the HS-SCCH order is a L1/physical layer signaling message (or command). In an aspect, UE 102 and/or secondary uplink carrier manager 104 may include a carrier activating component 252 to perform this functionality.

In an aspect, at block 204, methodology 200 may include determining whether the UE has data available for transmission from the UE to the base station. For example, in an aspect, UE 102 and/or secondary uplink carrier manager 104 may include a specially programmed processor module, or a processor executing specially programmed code stored in a memory, to determine whether UE 102 has data available for transmission from the UE to base station 112 and/or network entity 110.

For instance, in an aspect, when UE 102 and/or secondary uplink carrier manager 104 receives a message (e.g., HS-SCCH order) from base station 112 instructing UE 102 to activate secondary uplink carrier 124, UE 102 and/or secondary uplink carrier manager 104 activates secondary uplink carrier 124 and determines whether UE 102 has any data to transmit on the UL (e.g., one of the UL carriers) to base station 112. For example, UE 102 and/or secondary uplink carrier manager 104 may determine whether UE 102 has any data to transmit on the UL by checking the status of buffers at the UE (e.g., status of transmit buffers at the UE).

In an additional aspect, UE 102 and/or secondary uplink carrier manager 104 may determine whether UE 102 has data to transmit on the uplink when UE 102 does not receive any serving grants (SGs) from base station 102 with the message instructing the UE to activate the secondary uplink carrier. For example, the SG determines transmission power on a dedicated physical data channel (DPDCH) or enhanced-DPDCH allocated or assigned by the base station, generally by a serving base station. In an aspect, UE 102 and/or secondary uplink carrier manager 104 may include a data transmission determining component 254 to perform this functionality.

In an aspect, at block 206, methodology 200 may include computing a UPH value of the secondary uplink carrier in response to determining that the UE has data available for transmission. For example, in an aspect, UE 102 and/or secondary uplink carrier manager 104 may include a specially programmed processor module, or a processor executing specially programmed code stored in a memory, to compute UPH value 106 of secondary uplink carrier 124 in response to determining that UE 102 has data available for transmission.

For instance, UPH value 106 of a secondary uplink carrier 124 may be generally defined as a ratio of maximum UE transmission power and DPCCH code power and computed by averaging the UPH values over a duration of 100 ms. For example, in an aspect, UPH value 106 of secondary uplink carrier 124 may be computed using the formula UPH=P_{max,tx max}/P_{DPCCH}, where P_{max,tx max}min {maximum allowed UL TX Power, Pₘₐₓ}, wherein maximum allowed UL TX Power is set by network entity 110 and/or base station 120, Pₘₐₓ is UE nominal maximum output power according to UE power class, and/or P_{DPCCH} is transmitted code power on DPCCH.

In an aspect, UPH value 106 of secondary uplink carrier 124 may be computed when UE 102 and/or secondary uplink carrier manager 104 determines that UE 102 has data available for transmission on the UL from UE 102 to base station 112 and/or network entity 110. For example, in a dual cell E-DCH configuration (e.g., configured with primary and secondary uplink carriers) as described above, scheduled data is typically sent on the secondary uplink carrier (e.g., 124) first and any data left over for transmitting on the UL is then sent on the primary uplink carrier (e.g., 122). That is, the primary uplink carrier is used along with the secondary uplink carrier for transmitting data from the UE to the base station when the secondary uplink carrier does not have the capability (e.g., resources, UPH, SGs, etc.) to transmit all the data available for transmission on the uplink. The non-scheduled data, however, is generally transmitted on the primary uplink carrier (e.g., 122). In an aspect, UE 102 and/or secondary uplink carrier manager 104 may include a UPH computing component 256 to perform this functionality.

In an additional or optional aspect, UPH value 106 of secondary uplink carrier 124 may be computed (and/or reported, as described below) within a time period that is less than 100 ms after the activation of the secondary uplink carrier. For example, UE 102 and/or secondary uplink carrier manager 104 may compute UPH value to base station 120, for example, within 50 ms or 75 ms after activation of the secondary uplink carrier. This will ensure base station 112 has the correct UPH information from the UE instead of the UE reporting a default value of 0 or reporting an arbitrary value. In a further additional aspect, UPH values of the secondary uplink carrier may be reported based on, for example, a table index (e.g., 0-31) as defined in 3GPP Specifications. In an additional aspect, empty slots created by compressed mode or discontinuous uplink DPCCH transmission are not considered when computing UPH value 106 of the secondary uplink carrier.

In an aspect, at block 208, methodology 200 may include transmitting the computed UPH value to the base station. For example, in an aspect, UE 102 and/or secondary uplink carrier manager 104 may include a specially programmed processor module, or a processor executing specially programmed code stored in a memory, to transmit computed UPH value 106 of secondary uplink carrier 124 to base station 112 and/or network entity 110.

In an aspect, UPH value 106 of secondary uplink carrier 124 is transmitted (or reported) by UE 102 to base station 112 and/or network entity 110 as part of the scheduling information (SI) parameter, with the length of UPH field, e.g., at 5 bits. For example, in an aspect, the SI parameter may be used by UE 102 to indicate to a serving base station (e.g., base station 112) the amount of resources (e.g., serving grants) the UE needs for transmitting data on the UL. The SI parameter is typically located at the end of the media access control (MAC)-e or MAC-i protocol data unit (PDU) and is used to provide the serving base station (e.g., base station 112) with a better view of the amount of resources needed by the UE and the amount of resources the UE can actually use. The transmission of SI from the UE may be initiated due to the quantization of the transport block sizes that can be supported or based on triggers defined in subclause 11.8.1.6 of TS 25.321 of 3GPP Specifications. In an additional or optional aspect, when SI is transmitted, the contents of SI are updated in new transmissions with the buffer status after application of the E-DCH transport format combination indication (E-TFCI) selection procedure as described in subclause 11.8.1.4 of TS 25.321.

In an additional aspect, the SI parameter may be reported independently on each of the activated uplink frequencies or carriers with UPH value as one of the fields. That is, in a dual carrier E-DCH configuration, the SI parameter may be reported independently (e.g., separately) for the primary and secondary uplink carriers. For instance, the UPH value of an uplink carrier (or frequency) indicates the ratio of the maximum UE transmission power and the corresponding DPCCH code power of that carrier (or frequency). In an aspect, UE 102 and/or secondary uplink carrier manager 104 may include a UPH value transmission component 258 to perform this functionality.

In an optional aspect, at block 210, methodology 200 may optionally include receiving a serving grant for the secondary uplink carrier from the base station in response to the transmission of the computed UPH value. For example, in an aspect, UE 102 and/or secondary uplink carrier manager 104 may include a specially programmed processor module, or a processor executing specially programmed code stored in a memory, to receive a serving grant (SG) for secondary uplink carrier 124 from base station 112 in response to the transmission of the computed UPH value (e.g. UPH value 106). When UE 102 receives the SG from the base station, UE 102 may transmit data on secondary uplink carrier 124 to base station 112 and/or network entity 110. In an aspect, UE 102 and/or secondary uplink carrier manager 104 may optionally include a serving grant receiving component 260 to perform this functionality.

Thus, as described above, reporting of secondary uplink carrier UPH values may be achieved.

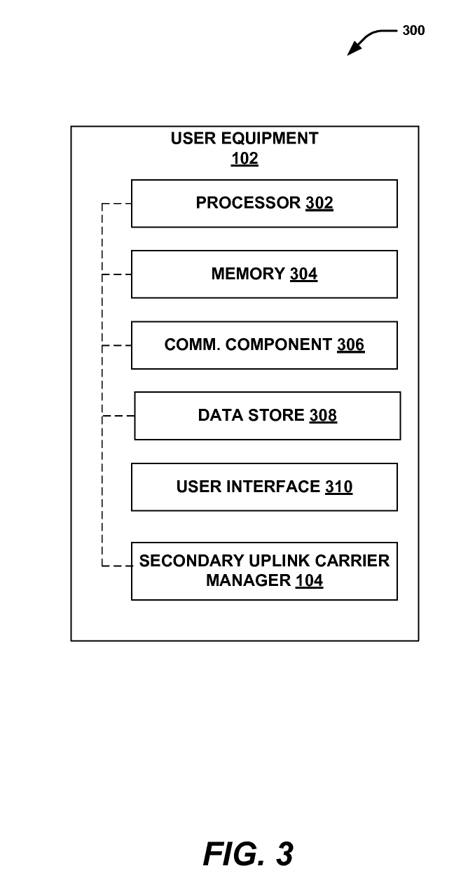

Referring to FIG. 3, in an aspect, UE 102, for example, including secondary uplink carrier manager 104, may be or may include a specially programmed or configured computer device to perform the functions described herein. In one aspect of implementation, UE 102 may include secondary uplink carrier manager 104 and its sub-components, including carrier activating component 252, data transmission determining component 254, UPH computing component 256, UPH value transmission component 258, and/or serving grant receiving component 260, such as in specially programmed computer readable instructions or code, firmware, hardware, or some combination thereof.

In an aspect, for example as represented by the dashed lines, secondary uplink carrier manager 104 may be implemented in or executed using one or any combination of processor 302, memory 304, communications component 306, and data store 308. For example, secondary uplink carrier manager 104 may be defined or otherwise programmed as one or more processor modules of processor 302. Further, for example, secondary uplink carrier manager 104 may be defined as a computer-readable medium (e.g., a non-transitory computer-readable medium) stored in memory 304 and/or data store 308 and executed by processor 302. Moreover, for example, inputs and outputs relating to operations of secondary uplink carrier manager 104 may be provided or supported by communications component 306, which may provide a bus between the components of computer device 300 or an interface for communication with external devices or components.

UE 102 may include processor 302 specially configured to carry out processing functions associated with one or more of components and functions described herein. Processor 302 can include a single or multiple set of processors or multi-core processors. Moreover, processor 302 can be implemented as an integrated processing system and/or a distributed processing system.

User equipment 102 further includes memory 304, such as for storing data used herein and/or local versions of applications and/or instructions or code being executed by processor 302, such as to perform the respective functions of the respective entities described herein. Memory 304 can include any type of memory usable by a computer, such as random access memory (RAM), read only memory (ROM), tapes, magnetic discs, optical discs, volatile memory, non-volatile memory, and any combination thereof.

Further, user equipment 102 includes communications component 306 that provides for establishing and maintaining communications with one or more parties utilizing hardware, software, and services as described herein. Communications component 306 may carry communications between components on user equipment 102, as well as between user and external devices, such as devices located across a communications network and/or devices serially or locally connected to user equipment 102. For example, communications component 306 may include one or more buses, and may further include transmit chain components and receive chain components associated with a transmitter and receiver, respectively, or a transceiver, operable for interfacing with external devices.

Additionally, user equipment 102 may further include data store 308, which can be any suitable combination of hardware and/or software, that provides for mass storage of information, databases, and programs employed in connection with aspects described herein. For example, data store 308 may be a data repository for applications not currently being executed by processor 302.

User equipment 102 may additionally include a user interface component 33 operable to receive inputs from a user of user equipment 102, and further operable to generate outputs for presentation to the user. User interface component 310 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 310 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

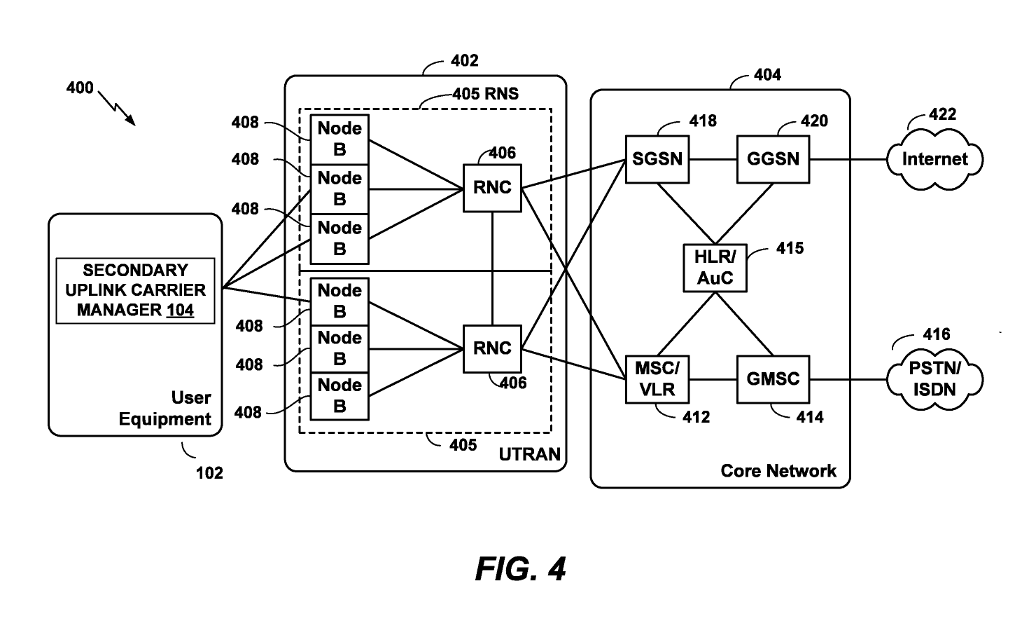

Referring to FIG. 4, by way of example and without limitation, the aspects of the present disclosure are presented with reference to a UMTS system 400 employing a W-CDMA air interface, and may include a UE 102 executing an aspect of secondary uplink carrier manager 104 of FIG. 1. A UMTS network includes three interacting domains: a Core Network (CN) 404, a UMTS Terrestrial Radio Access Network (UTRAN) 402, and UE 102. In an aspect, as noted, UE 102 (FIG. 1) may be configured to perform functions thereof, for example, including reporting UPH of a secondary uplink carrier at the UE. Further, UTRAN 402 may comprise network entity 110 and/or base station 112 (FIG. 1), which in this case may be respective ones of the Node Bs 408. In this example, UTRAN 402 provides various wireless services including telephony, video, data, messaging, broadcasts, and/or other services. The UTRAN 402 may include a plurality of Radio Network Subsystems (RNSs) such as a RNS 405, each controlled by a respective Radio Network Controller (RNC) such as an RNC 404. Here, the UTRAN 402 may include any number of RNCs 404 and RNSs 405 in addition to the RNCs 404 and RNSs 405 illustrated herein. The RNC 404 is an apparatus responsible for, among other things, assigning, reconfiguring, and releasing radio resources within the RNS 405. The RNC 404 may be interconnected to other RNCs (not shown) in the UTRAN 402 through various types of interfaces such as a direct physical connection, a virtual network, or the like, using any suitable transport network.

Communication between UE 102 and Node B 408 may be considered as including a physical (PHY) layer and a medium access control (MAC) layer. Further, communication between UE 102 and RNC 404 by way of a respective Node B 408 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 44.331 v4.1.0, incorporated herein by reference.

The geographic region covered by the RNS 405 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 408 are shown in each RNS 405; however, the RNSs 405 may include any number of wireless Node Bs. The Node Bs 408 provide wireless access points to a CN 404 for any number of mobile apparatuses, such as UE 102, and may be network entity 110 and/or base station 112 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 408. The DL, also called the forward link, refers to the communication link from a Node B 408 to a UE 102 (e.g., link 126 or 128), and the UL, also called the reverse link, refers to the communication link from a UE 102 to a Node B 408 (e.g., link 122 or 124).

The CN 404 interfaces with one or more access networks, such as the UTRAN 402. As shown, the CN 404 is a GSM core network. However, as those skilled in the art will recognize, the various concepts presented throughout this disclosure may be implemented in a RAN, or other suitable access network, to provide UEs with access to types of CNs other than GSM networks.

The CN 404 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 404 supports circuit-switched services with a MSC 412 and a GMSC 414. In some applications, the GMSC 414 may be referred to as a media gateway (MGW). One or more RNCs, such as the RNC 404, may be connected to the MSC 412. The MSC 412 is an apparatus that controls call setup, call routing, and UE mobility functions. The MSC 412 also includes a VLR that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) 415 containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR 415 to determine the UE's location and forwards the call to the particular MSC serving that location.

The CN 404 also supports packet-data services with a serving GPRS support node (SGSN) 418 and a gateway GPRS support node (GGSN) 420. GPRS, which stands for General Packet Radio Service, is designed to provide packet-data services at speeds higher than those available with standard circuit-switched data services. The GGSN 420 provides a connection for the UTRAN 402 to a packet-based network 422. The packet-based network 422 may be the Internet, a private data network, or some other suitable packet-based network. The primary function of the GGSN 420 is to provide the UEs 102 with packet-based network connectivity. Data packets may be transferred between the GGSN 420 and the UEs 102 through the SGSN 418, which performs primarily the same functions in the packet-based domain as the MSC 412 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 408 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 408 over the HS-DPCCH to indicate whether it correctly decoded a packet on the downlink.

HS-DPCCH further includes feedback signaling from the UE 102 to assist the Node B 408 in taking the right decision in terms of modulation and coding scheme and precoding weight selection, this feedback signaling including the CQI and PCI.

HSPA Evolved or HSPA+ is an evolution of the HSPA standard that includes MIMO and 44-QAM, enabling increased throughput and higher performance. That is, in an aspect of the disclosure, the Node B 408 and/or the UE 102 may have multiple antennas supporting MIMO technology. The use of MIMO technology enables the Node B 408 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 408 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

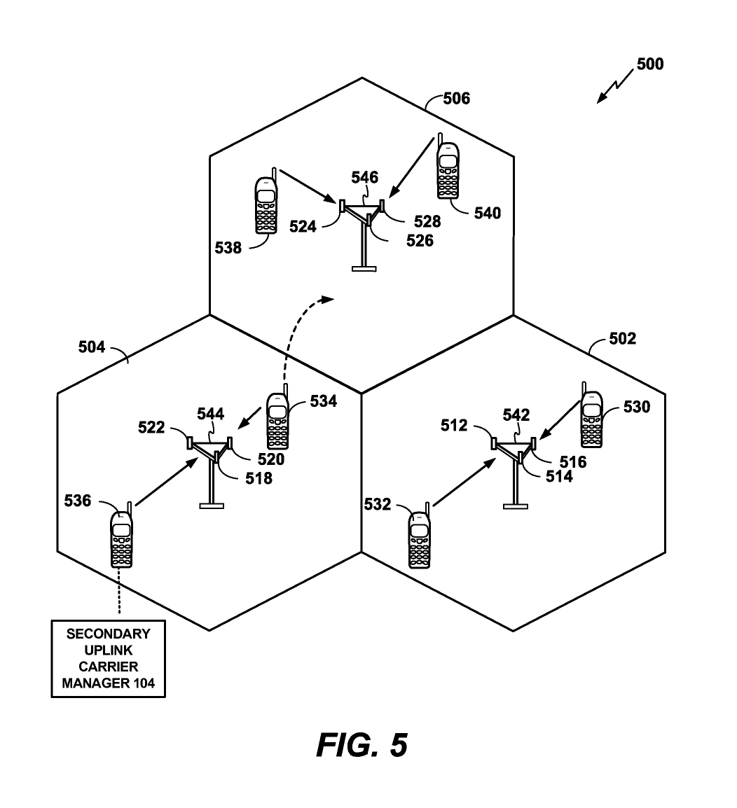

Referring to FIG. 5, an access network 500 in a UTRAN architecture is illustrated, and may include one or more UEs 530, 532, 534, 536, 538, and 540, which may be the same as or similar to UE 102 (FIG. 1) in that they are configured to include secondary uplink carrier manager 104 (FIG. 1; for example, illustrated here as being associated with UE 536) for reporting UPH of a secondary uplink carrier at the UE. The multiple access wireless communication system includes multiple cellular regions (cells), including cells 502, 504, and 506, each of which may include one or more sectors. The multiple sectors can be formed by groups of antennas with each antenna responsible for communication with UEs in a portion of the cell. For example, in cell 502, antenna groups 512, 514, and 516 may each correspond to a different sector. In cell 504, antenna groups 518, 520, and 522 each correspond to a different sector. In cell 506, antenna groups 524, 526, and 528 each correspond to a different sector. UEs, for example, 530, 532, etc. may include several wireless communication devices, e.g., User Equipment or UEs, including secondary uplink carrier manager 104 of FIG. 1, which may be in communication with one or more sectors of each cell 502, 504 or 506. For example, UEs 530 and 532 may be in communication with Node B 542, UEs 534 and 536 may be in communication with Node B 544, and UEs 538 and 540 can be in communication with Node B 546. Here, each Node B 542, 544, 546 is configured to provide an access point to a CN 404 (FIG. 4) for all the UEs 530, 532, 534, 536, 538, 540 in the respective cells 502, 504, and 506. Additionally, each Node B 542, 544, 546 may be base station 112 and/or and UEs 530, 532, 534, 536, 538, 540 may be UE 102 of FIG. 1 and may perform the methods outlined herein.

As the UE 534 moves from the illustrated location in cell 504 into cell 506, a serving cell change (SCC) or handover may occur in which communication with the UE 534 transitions from the cell 504, which may be referred to as the source cell, to cell 506, which may be referred to as the target cell. Management of the handover procedure may take place at the UE 534, at the Node Bs corresponding to the respective cells, at a radio network controller 406 (FIG. 4), or at another suitable node in the wireless network. For example, during a call with the source cell 504, or at any other time, the UE 534 may monitor various parameters of the source cell 504 as well as various parameters of neighboring cells such as cells 506 and 502. Further, depending on the quality of these parameters, the UE 534 may maintain communication with one or more of the neighboring cells. During this time, the UE 534 may maintain an Active Set, that is, a list of cells that the UE 534 is simultaneously connected to (i.e., the UTRA cells that are currently assigning a downlink dedicated physical channel DPCH or fractional downlink dedicated physical channel F-DPCH to the UE 534 may constitute the Active Set). In any case, UE 534 may perform the reselection operations described herein.

Further, the modulation and multiple access scheme employed by the access network 500 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

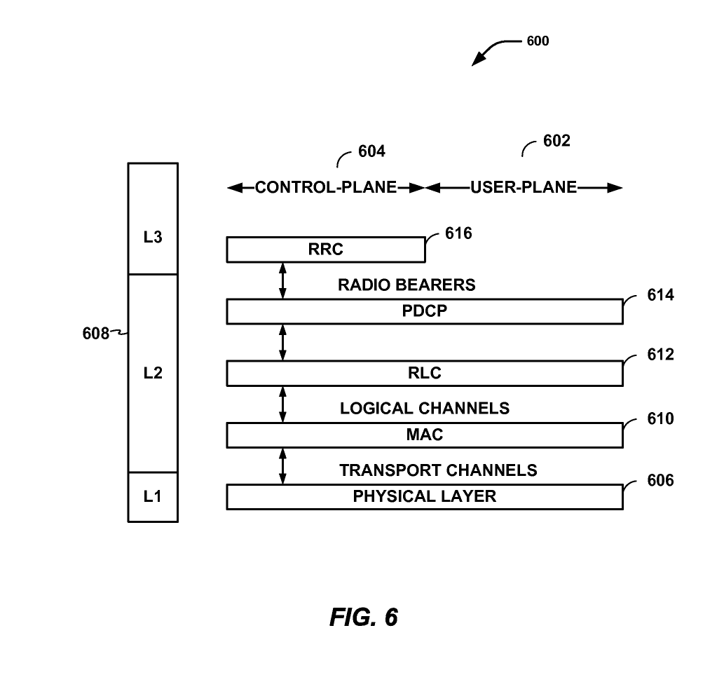

The radio protocol architecture may take on various forms depending on the particular application. An example for an HSPA system will now be presented with reference to FIG. 6. FIG. 6 is a conceptual diagram illustrating an example of the radio protocol architecture for the user plane 602 and control plane 604.

Turning to FIG. 6, the radio protocol architecture for the UE, for example, UE 102 of FIG. 1 configured to include secondary uplink carrier manager 104 (FIG. 1) for reporting UPH of a secondary uplink carrier at the UE (e.g., UE 102) is shown with three layers: Layer 1 (L1), Layer 2 (L2), and Layer 3 (L3). Layer 1 is the lowest layer and implements various physical layer signal processing functions. Layer 1 (L1 layer) is referred to herein as the physical layer 606. Layer 2 (L2 layer) 608 is above the physical layer 606 and is responsible for the link between the UE and Node B over the physical layer 606.

In the user plane, L2 layer 608 includes a media access control (MAC) sublayer 610, a radio link control (RLC) sublayer 612, and a packet data convergence protocol (PDCP) 614 sublayer, which are terminated at the Node B on the network side. Although not shown, the UE may have several upper layers above L2 layer 608 including a network layer (e.g., IP layer) that is terminated at a PDN gateway on the network side, and an application layer that is terminated at the other end of the connection (e.g., far end UE, server, etc.).

The PDCP sublayer 614 provides multiplexing between different radio bearers and logical channels. The PDCP sublayer 614 also provides header compression for upper layer data packets to reduce radio transmission overhead, security by ciphering the data packets, and handover support for UEs between Node Bs. The RLC sublayer 612 provides segmentation and reassembly of upper layer data packets, retransmission of lost data packets, and reordering of data packets to compensate for out-of-order reception due to hybrid automatic repeat request (HARQ). The MAC sublayer 610 provides multiplexing between logical and transport channels. The MAC sublayer 610 is also responsible for allocating the various radio resources (e.g., resource blocks) in one cell among the UEs. The MAC sublayer 610 is also responsible for HARQ operations.

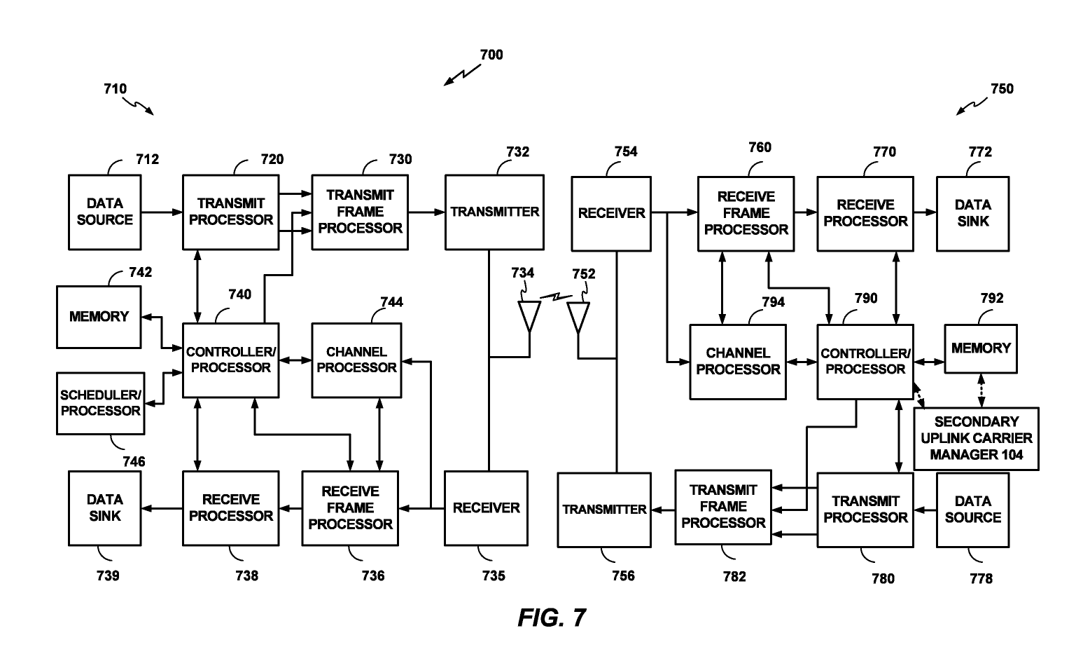

FIG. 7 is a block diagram of a Node B 710 in communication with a UE 750, where the Node B 710 may be base station 112 of network entity 110 and/or the UE 750 may be the same as or similar to UE 102 of FIG. 1 in that it is configured to include secondary uplink carrier manager 104 (FIG. 1) for reporting UPH of a secondary uplink carrier at the UE, in controller/processor 740 and/or memory 742. In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and de-spreads the symbols, and then determines the most likely signal constellation points transmitted by the Node B 710 based on the modulation scheme. These soft decisions may be based on channel estimates computed by the channel processor 794. The soft decisions are then decoded and de-interleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receive processor 770, the controller/processor 770 may also use an acknowledgement (ACK) and/or negative acknowledgement (NACK) protocol to support retransmission requests for those frames.

In the uplink, data from a data source 778 and control signals from the controller/processor 770 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of reporting a user equipment (UE) transmission power headroom (UPH) of a secondary uplink carrier at the UE, comprising:
activating the secondary uplink carrier upon receiving a message from a base station in communication with the UE to activate the secondary uplink carrier;
determining whether the UE has data available for transmission from the UE to the base station;
computing a UPH value of the secondary uplink carrier in response to determining that the UE has data available for transmission; and
transmitting the computed UPH value to the base station.

2. The method of claim 1, further comprising:
receiving a serving grant for the secondary uplink carrier from the base station in response to the transmission of the computed UPH value.

3. The method of claim 1, wherein the UPH value is computed over a duration less than 100 milliseconds after the activation of the secondary uplink carrier.

4. The method of claim 1, wherein the computed UPH value is transmitted to the base station in a scheduling information (SI) parameter.

5. The method of claim 1, wherein the message activating the secondary uplink carrier is a high speed-shared control channel (HS-SCCH) order activating the uplink secondary carrier.

6. The method of claim 1, wherein the UPH value of the secondary uplink carrier is a ratio of a maximum UE transmission power of the secondary uplink carrier and a dedicated physical control channel (DPCCH) code power of the secondary uplink carrier.

7. The method of claim 1, wherein the base station is a serving base station of the UE.

8. A non-transitory computer readable medium storing computer executable code for reporting a user equipment (UE) transmission power headroom (UPH) of a secondary uplink carrier at the UE, comprising:
code activating the secondary uplink carrier upon receiving a message from a base station in communication with the UE to activate the secondary uplink carrier;
code for determining whether the UE has data available for transmission from the UE to the base station;
code for computing a UPH value of the secondary uplink carrier in response to determining that the UE has data available for transmission; and
code for transmitting the computed UPH value to the base station.

9. The computer readable medium of claim 8, further comprising:
code for receiving a serving grant for the secondary uplink carrier from the base station in response to the transmission of the computed UPH value.

10. The computer readable medium of claim 8, wherein the UPH value is computed over a duration less than 100 milliseconds after the activation of the secondary uplink carrier.

11. The computer readable medium of claim 8, wherein the computed UPH value is transmitted to the base station in a scheduling information (SI) parameter.

12. The computer readable medium of claim 8, wherein the message activating the secondary uplink carrier is a high speed-shared control channel (HS-SCCH) order activating the uplink secondary carrier.

13. The computer readable medium of claim 8, wherein the UPH value of the secondary uplink carrier is a ratio of a maximum UE transmission power of the secondary uplink carrier and a dedicated physical control channel (DPCCH) code power of the secondary uplink carrier.

14. The computer readable medium of claim 8, wherein the base station is a serving base station of the UE.

15. An apparatus for reporting a user equipment (UE) transmission power headroom (UPH) of a secondary uplink carrier at the UE, comprising:
a carrier activating component to activate the secondary uplink carrier upon receiving a message from a base station in communication with the UE to activate the secondary uplink carrier;
a data transmission determining component to determine whether the UE has data available for transmission from the UE to the base station;
a UPH computing component to compute a UPH value of the secondary uplink carrier in response to determining that the UE has data available for transmission; and
a UPH value transmission component to transmit the computed UPH value to the base station.

16. The method of claim 15, further comprising:
a serving grant receiving component to receive a serving grant for the secondary uplink carrier from the base station in response to the transmission of the computed UPH value.

17. The method of claim 15, wherein the UPH computing component is further configured to compute the UPH value over a duration less than 100 milliseconds after the activation of the secondary uplink carrier.

18. The method of claim 15, wherein the UPH value transmission component is further configured to transmit the computed UPH value to the base station in a scheduling information (SI) parameter.

19. The method of claim 15, wherein the carrier activating component is further configured to activate the secondary uplink carrier upon receiving a high speed-shared control channel (HS-SCCH) order activating the uplink secondary carrier.

20. The method of claim 15, wherein the UPH computing component is further configured to compute the UPH value of the secondary uplink carrier by calculating a ratio of a maximum UE transmission power of the secondary uplink carrier and a dedicated physical control channel (DPCCH) code power of the secondary uplink carrier.
